(19) United States
(12) Patent Application Publication
(10) Pub. No.: US 2005/0157352 A1
(43) Pub. Date: Jul. 21, 2005

(54) Scan image correction device and method thereof

(76) Inventor: Jong-Cheol Oh, Suwon-si (KR)

Correspondence Address: STANZIONE & KIM, LLP, 1740 N STREET, N.W., FIRST FLOOR, WASHINGTON, DC, 20036, US

(21) Appl. No.: 11/020,161

(22) Filed: Dec. 27, 2004

(30) Foreign Application Priority Data
Jan. 19, 2004 (KR) 2004-4000

(51) Int. Cl. H04N 1/04; H04N 1/047

(52) U.S. Cl. 358/474; 358/498

(57) ABSTRACT

A scan image correction device includes a scanning part to scan an image of a document in a block unit, an electro static discharge (ESD) determination part to determine a presence of an external ESD while the scanning part scans the image, a document feeding adjustment part to feed the document backward by the block unit to allow the scanning part to re-scan the image if the ESD determination part determines that the ESD present, and an image process part to receive the image as an ESD free scan image and to process the received image. Accordingly, the scan image correction device prevents one or more black lines from appearing by an influence of the ESD during scanning so that a high-quality scan image can be provided.

### CROSS-REFERENCE TO RELATED APPLICATIONS

This application claims the benefit under U.S.C. § 119 of Korean Patent Application No. 2004-4000, filed on Jan. 19, 2004, in the Korean Intellectual Property Office, the disclosure of which is incorporated herein in its entirety and by reference.

### BACKGROUND OF THE INVENTION

1. Field of the Invention

The present general inventive concept relates to a scan image correction device and a method thereof. More particularly, the present general inventive concept relates to a scan image correction device which detects an error occurred by an external factor to generate a better image quality, and a method thereof.

2. Description of the Related Art

A general scan image generation device, such as a multi-function peripheral (MFP), a facsimile, a copier, or an image scanner, generally comprises a charge coupled device (CCD) or a contact image sensor (CIS) as an image sensor which receives an image in a line unit. The scan image generation device further comprises a motor for vertically moving the image sensor by the line unit.

FIG. 1 is a schematic view illustrating a conventional scan image generation device, and FIG. 2 is a schematic view illustrating a conveyance path of the conventional scan image generation device of FIG. 1.

A conventional scan image generation device detects data of a document in a read width such as one line or one band, and converts the data into an electronic signal. Referring to FIGS. 1 and 2, the scan image generation device comprises a scanning head 102, a guide rail 103, a carriage return motor 104, a conveyance belt 105, a pick up roller 107, a driving roller 108, a discharge roller 109, and a reference sheet 110. The scanning head 102 is configured a certain distance apart from an effective read area of a document 101 to scan image information from the document 101. The guide rail 103 guides a right and left reciprocal movement of the scanning head 102. The carriage return motor 104 provides the scanning head 102 with a driving force for the right and left reciprocal movement. The conveyance belt 105 is engaged with the carriage return motor 104 and the scanning head 102, and transmits the driving force of the carriage return motor 104 to the scanning head 102. The pick up roller 107 picks up the document 101 from a stack of documents in a cassette 106 and inserts the picked up document 101 into a document conveyance path. The driving roller 108 conveys the document 101 picked up by the pick-up roller 107 to the effective read area of the scanning head 102. The discharge roller 109 discharges the document 101 when the scanning head 102 finishes scanning the document 101. The reference sheet 110 is included in a movement path of the scanning head 102, and is attached to a free area outside of the effective read area of the scanning head 102. A reference pattern readable by the scanning head 102 is recorded on the reference sheet 110.

The scanning head 102 has lamps 111 at an end thereof facing the document 101 such that light emitted from the lamps 111 is applied to the document 101. The scanning head 102 has a CCD 112 therein for perceiving light reflected from the document 101 and converting the reflected light into electronic data. The scanning head 102 also has a lens 113 between the lamps 111 and the CCD 112, for focusing the reflected light such that the light reflected from the document 101 reaches a certain area of the CCD 112. The lamps 111, the CCD 112, and the lens 113 are constructed as one body.

A scanner using the CCD generally uses a halogen lamp or a fluorescent lamp as a light source, whereas a scanner using the CIS generally uses a small sized light emitting diode (LED) as a light source. A monochromatic CIS emits a white light, while a color CIS emits a color light from, by turns, a red, a blue, and a green LED to read a light amount with respect to each LED, and recognizes colors of a document by a combination of the three light amounts.

Briefly explaining the operation principle of the CIS, the light emitted from an LED array is reflected by the document and reaches a photoelectric transducer via a self-focusing lens. An output value of the photoelectric transducer varies depending on a brightness of the light reflected by the document. The output value of the photoelectric transducer is amplified to generate a scan image of the document.

A scan image generation device has a fixed width for scanning an area at one time. FIG. 3 shows an example of a scanning area that the scanner head 102 of the conventional scan image generation device can scan at one time.

Generally, the scanner head 102 can scan 1 pixel*128 pixels if a monotone type is applied, and 1 pixel*160 pixels if color type is applied. FIG. 3 shows when the monotone type is applied. Here, the scanning head 102 consecutively scans 1 pixel*128 pixels by scanning each pixel from a first pixel to a last pixel.

When the scan image generation device receiving an image in a line unit or a block unit is used, irrespective of a document status, black lines can appear on the document as the scan image is printed or transmitted, caused by an external factor, such as an electro static discharge (ESD) and an electro fast transient (EFT). The black lines degrade readability and therefore, a low-quality image is generated.

### SUMMARY OF THE INVENTION

The present general inventive concept provides a scan image correction device which determines the presence of an ESD occurring when the scan image generation device scans an image, to prevent black lines on the document, and a method thereof.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a scan image correction device comprising a scanning part to scan an image of a document in a block unit, an electro static discharge (ESD) determination part to determine a presence of an ESD while the scanning part scans the image, a document feeding adjustment part to feed the document backward by a predetermined block unit to be re-scanned by the scanning part if the ESD determination part determines that the ESD is present, and an image process part to receive the image as an ESD free image and to process the received image.

The ESD determination part may comprise an edge area detection part to detect an edge area with respect to the document, and the ESD determination part can determine that the ESD is present if the image being scanned by the scanning part exists in the edge area detected by the edge area detection part.

The image process part may comprise a print part to print the ESD free image.

The image process part may further comprise an interface part connected to external equipment, and a transmission part to transmit the ESD-free image via the interface part to the external equipment.

The foregoing and/or other aspects and advantages of the present general inventive concept may also be achieved by providing a scan image correction method comprising scanning an image of a document in a predetermined block unit, determining a presence of an ESD during the scanning of the image in the predetermined block unit, feeding the document backward by the predetermined block unit to re-scan the document if the ESD is determined to be present, and reading out an ESD-free image and processing the ESD-free image.

The determining of the presence of the ESD may comprise detecting an edge area with respect to the document, and if the image being scanned exists in the edge area, determining that the ESD is present.

The reading out and processing of the ESD-free image may comprise printing the ESD-free image.

The reading out and processing of the ESD-free image may further comprise connecting an interface part to external equipment, and transmitting the ESD-free image to the connected external equipment.

By the above process, a scan image correction device according to the present general inventive concept can determine the presence of the ESD occurring when the scan image generation device scans an image, to prevent black lines on the image.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a conventional scanner;

FIG. 2 is a view illustrating a conveyance path of the conventional scanner of FIG. 1;

FIG. 3 is a view illustrating a scanning area that a scanner head of FIG. 1 can scan at one time;

FIG. 4 is a block diagram illustrating a scan image correction device according to an embodiment of the present general inventive concept;

FIG. 5 is a flow chart illustrating a method of correcting a scan image according to the scan image correction device of FIG. 4;

FIG. 6 is a block diagram illustrating a scan image correction device according to another embodiment of the present general inventive concept; and

FIG. 7 is a flow chart illustrating a method of correcting a scan image according to the scan image correction device of FIG. 6.

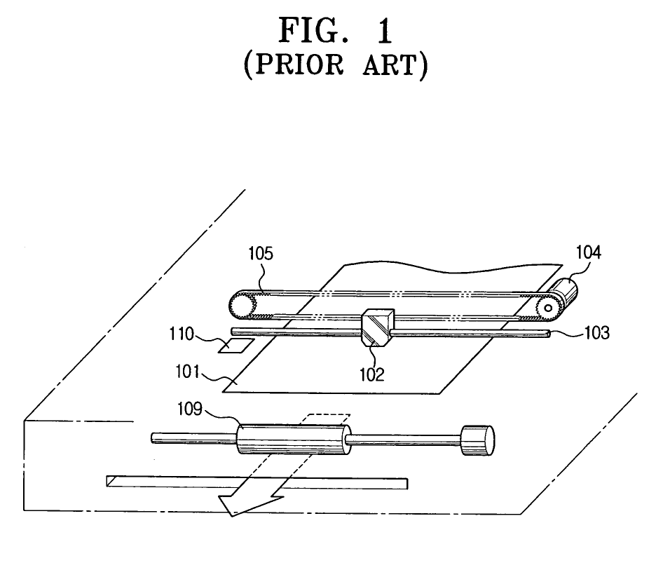

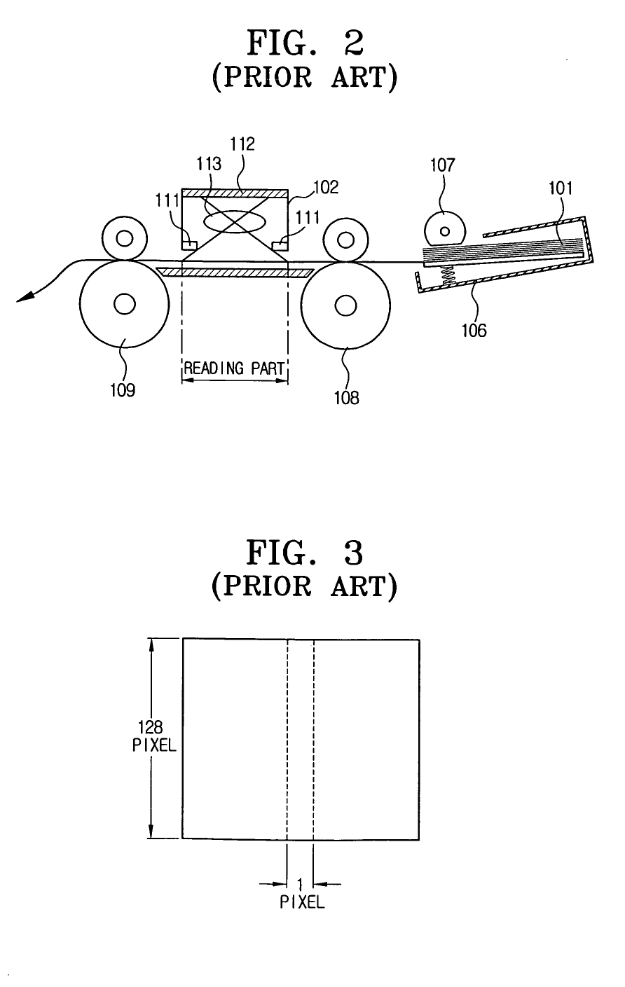

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

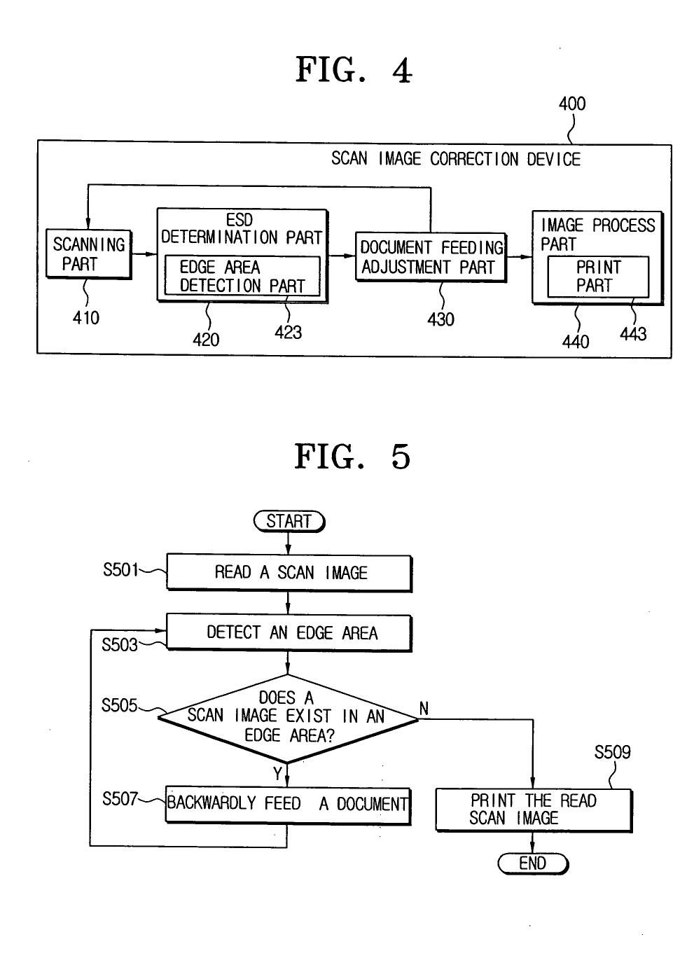

FIG. 4 is a block diagram illustrating a scan image correction device according to an embodiment of the present general inventive concept. The scan image correction device 400 comprises a scanning part 410, an ESD (electro static discharge) determination part 420, a document feeding adjustment part 430, and an image process part 440. The ESD determination part 420 can have an edge area detection part 423. The image process part 440 can have a print part 443.

The scanning part 410 scans an image of a document in a block unit. The scanning part 410 may have a charge coupled device (CCD) or a contact image sensor (CIS) as an image sensor.

The CCD is a memory arranged such that an output of a semiconductor can be input to an adjacent semiconductor. The CCD can be charged by light or electricity. The CCD can be used to store an image in a digital camera, a video camera, and an optical scanner. The CCD is an arrangement of light condensers in a sealed area, and converts a pattern of incident photon energy into a binary analog signal.

The CCD can perform two operations. First, the CCD converts the photon energy into an electric charge, and second, the CCD moves the electric charge to read in the same. The process of moving the electric charge is known as a bucket brigade, which is a chain of bucket relays putting out the electric charge. One value is read in, and then the remaining values are shifted according to the read in value. Reading the CCD is similar to reading a successive data stream from a shift register. When a data item of the data stream is fully read, the data stream is shifted for the next reading.

The CIS is an image sensor element used with devices such as a scanner and a facsimile. The CIS is in contact with a document to be read. If an LED (Light Emitting Diode) is used, an image can be read as a line unit.

The ESD determination part 420 determines whether there is an influence of an ESD while the scanning part 410 is scanning the image. The ESD is a rapid discharge of static electricity from a person or machine to another person or machine of a lower potential when the static electricity reaches thousands of volts. The static electricity discharge can be accompanied with a flame, and can cause one or more black lines on the scanned image.

The ESD determination part 420 can have the edge area detection part 423 to detect an edge area of the document being scanned. The document being scanned has a certain blank area around its boundary. This area is called the ‘edge’ area. The ESD determination part 420 determines that the ESD is present if the image being scanned by the scanning part 410 exists on the edge area detected by the edge area detection part 423. The determination is based on a phenomenon in which the black lines generated by the ESD generally extend to the edge area of the document.

The document feeding adjustment part 430 feeds back the document by a predetermined block unit such that the scanning part 410 can re-scan the image of the document, if the ESD determination part 420 determines that the ESD is present. The predetermined block unit is an interval of the document fed back by the document feeding adjustment part 430, and may be set to be the same as the block unit used by the scanning part 410 to scan the image of the document.

The image process part 440 then receives the scan image of the document as an ESD-free scan image and processes the ESD-free scan image. The print part 443 of the image process part 440 prints the ESD-free scan image.

FIG. 5 is a flow chart illustrating a method of correcting a scan image according to the scan image correction device 400 of FIG. 4. The scanning part 410 of the scan image correction device 400 scans the image of a document in the predetermined block unit to read the scan image (S501).

While the scanning part 410 reads the scan image from the document in the predetermined block unit, the edge area detection part 423 detects the edge area of the document (S503), and determines whether the scan image exists in the detected edge area (S505). When the scan image being read by the scanning part 410 exists in the edge area detected by the edge area detection part 423, the ESD determination part 420 determines that the ESD is present.

When the ESD determination part 420 determines that the ESD is present, the document feeding adjustment part 430 feeds the document backward by the predetermined block unit so that the document can be scanned again by the scanning part 410 from the previous scanning position (S507).

When the document feeding adjustment part 430 feeds the document backward, that is, in a direction opposite to a document feeding direction, the edge area detection part 423 detects an edge area for the back-fed document (S503), and determines whether the scan image exists in the detected edge area (S505). This process is repeated until the edge area detection part 423 determines that the scan image does not exist in the edge area. An influence of the ESD is temporary, and the above process is to prevent the black lines caused by the temporary influence of the ESD.

When the scan image does not exist in the edge area, the image process part 430 processes the ESD-free scan image of the document. The print part 443 prints the ESD-free scan image (S509). Accordingly, being presented in devices such as an image scanner and a copier, the scan image correction device 400 can prevent an occurrence of the black lines caused by the ESD and as a result, a high-quality scan image can be printed.

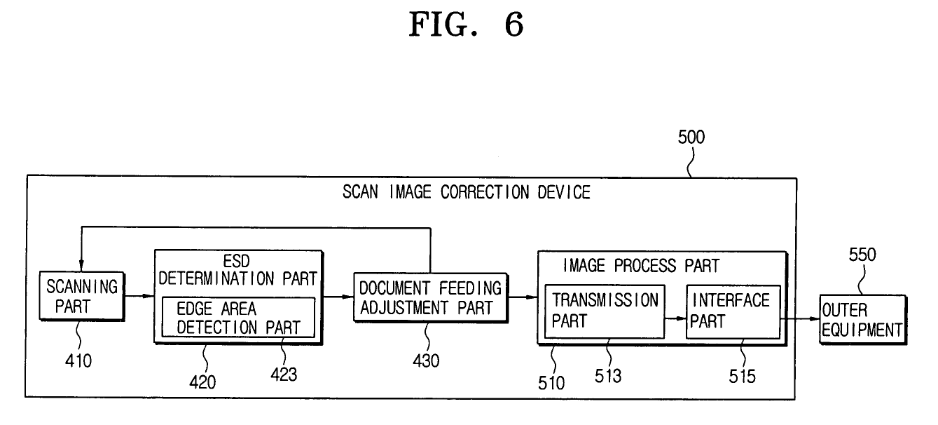

FIG. 6 is a block diagram of a scan image correction device 500 according to another embodiment of the present general inventive concept. Referring to FIGS. 4 and 6, the scan image correction device 500 comprises the scanning part 410, the ESD determination part 420, the document feeding adjustment part 430, and an image process part 510. The ESD determination part 420 can have the edge area detection part 423, and the image process part 510 can comprise a transmission part 513 and an interface part 515. The interface part 515 can be connected to external equipment 550 to transmit and receive data between the scan image correction device 500 and the external equipment 550. The scanning part 410, the ESD determination part 420, the edge area detection part 423, and the document feeding adjustment part 430 of the scan image correction device 500 are operated as in the scanning image correction device 400 of FIG. 4, and therefore, the same reference numbers are used, and an explanation thereof is omitted hereinafter for the sake of brevity.

The transmission part 513 transmits an ESD-free scan image via the interface part 515 to the connected outer equipment 550.

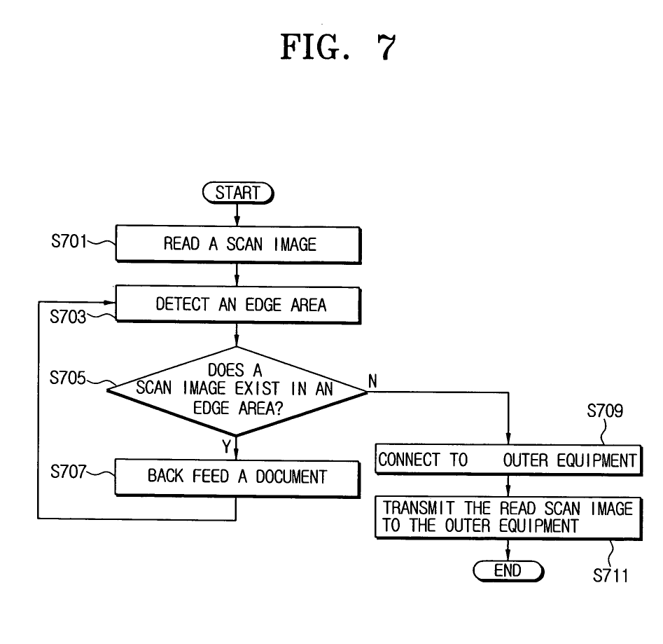

FIG. 7 is a flow chart illustrating a method of correcting a scan image according to the scan image correction device of FIG. 6. The scanning part 410 of the scan image correction device 400 scans an image of a document in a predetermined block unit (S701).

While the scanning part 410 scans the document to read the scan image in the predetermined block unit in a feeding direction, the edge area detection part 423 detects an edge area of the document (S703). If the scan image being scanned by the scanning part 410 exists in the edge area detected by the edge area detection part 423 (S705), the ESD determination part 420 determines that the ESD is present.

If the ESD determination part 420 determines that the ESD is present, the document feeding adjustment part 430 feeds the document backward, that is, in a direction opposite to the feeding direction, by the predetermined block unit to scan the document from the previous scanning position (S707).

When the document feeding adjustment part 430 feeds the paper backward, the edge area detection part 423 detects the edge area of the backwardly fed document (S703), and determines whether the scan image exists in the detected edge area (S705). This process is repeated until it is determined that there is no scan image in the edge area. Because an influence of the ESD occurs temporarily, the occurrence of black lines caused by the ESD influence can be prevented by the above process.

If a scan image does not exist in the edge area, the image process part 510 processes the scan image. The scan image correction device 500 can be connected with the external equipment 550 via the interface part 515 (S709), and the transmission part 513 transmits the scan image via the interface part 515 to the outer equipment 550 (S711). Based on the above process, when present in the devices such as a facsimile, the scan image correction device 500, can prevent the black lines caused by the ESD so that the scan image can be read out and transmitted.

Although the embodiments of the present general inventive concept describe a method of preventing black lines by the ESD, which obtains undamaged image quality by feeding a document backward if data is detected in the edge area, this should not be construed as limiting. Specifically, with the ESD influence, present data of a line or a block under the influence of the ESD may be overwritten with previous data, or simply be deleted, and the scanning operation can move to the next line or block. Those detection methods are substantially the same as the embodiments of the present general inventive concept described above, and only relates to a partial modification of an image quality, and therefore, those methods are considered to be included in the scope of the embodiments of the present general inventive concept.

The scan image correction device according to the present general inventive concept can prevent black lines by an ESD during scanning, and produce a high-quality scan image.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A scan image correction device comprising:
a scanning part to scan an image of a document in a block unit;
an electro static discharge (ESD) determination part to determine a presence of an ESD while the scanning part scans the image;
a document feeding adjustment part to feed the document backward by a predetermined block unit to allow the scanning part to re-scan the image if the ESD determination part determines that the ESD is present; and
an image process part to receive the image as an ESD free scan image and to process the received image.

2. The device as claimed in claim 1, wherein the ESD determination part comprises an edge area detection part to detect an edge area with respect to the document, and the ESD determination part determines that the ESD is present if the image being scanned by the scanning part exists in the edge area detected by the edge area detection part.

3. The device as claimed in claim 2, wherein the image process part comprises a print part to print the received image.

4. The device as claimed in claim 2, wherein the image process part further comprises:
an interface part connected to external equipment; and
a transmission part to transmit the received image via the interface part to the external equipment.

5. The device as claimed in claim 1, wherein the scanning part comprises one of a charged coupled device (CCD) and a contact image sensor (CIS).

6. The device as claimed in claim 1, wherein the predetermined block unit of the document feeding adjustment part, is the same as the block unit of the scanning part.

7. An image scanning apparatus comprising:
a scanning unit to sequentially scan a plurality of block units of a document, each of the plurality of block units having a portion of an image of the document therein, to read out the image of the document; and
an electro static discharge (ESD) detection unit to detect whether an ESD has influenced the portion of the image in each of the plurality of block units while the block units are sequentially scanned by the scanning unit,
wherein the scanning unit re-scans one of the plurality of block units when the ESD detection unit detects that the ESD has influenced the portion of the image in the one of the plurality of block unite.

8. The image scanning apparatus as claimed in claim 7, further comprising:
a document feeding adjustment unit to feed the document backward to allow the scanning unit to re-scan the one of the plurality of block units.

9. The image scanning apparatus as claimed in claim 7, wherein the ESD detection unit detects whether the portion of the image in each of the plurality of block units exists in an edge area of the document, and determines that the ESD has influenced the portion of the image when the portion of the image exists in the edge area.

10. The image scanning apparatus as claimed in claim 7, further comprising:
a printing unit to print the image of the document read out by the scanning unit when the ESD detection unit detects no influence of the ESD on the portion of the image in each of the plurality of block units.

11. The image scanning apparatus as claimed in claim 7, further comprising:
an interface to connect to external equipment; and
a transmission unit to transmit the image of the document read out by the scanning unit to the external equipment when the ESD detection unit detects no influence on the portion of the image in each of the plurality of block units.

12. A scan image correction method comprising:
scanning an image of a document in a predetermined block unit;
determining the presence of an ESD while the image is being scanned;
feeding the document backward by the predetermined block unit to re-scan the image if the ESD is determined to be present; and
reading out an ESD-free image from the document fed backward according to and processing the ESD-free image.

13. The method as claimed in claim 12, wherein the determining of the presence of the ESD comprises:
detecting an edge area with respect to the document, and if the image being scanned exists in the detected edge area, determining the external ESD to be present.

14. The method as claimed in claim 12, wherein the reading out and processing of the ESD-free image comprises:
printing the ESD-free image.

15. The method as claimed in claim 13, wherein the reading out and processing of the ESD-free image comprises:
connecting to an outer equipment; and
transmitting the ESD-free image to the outer equipment.

16. A method of scanning an image, the method comprising:
reading out an image by scanning a plurality of block units, each having a portion of the image;
determining whether an electro static discharge (ESD) has influenced the portion of the image of each of the plurality of block units as the plurality of block units are being scanned;
re-scanning one of the plurality of block units when the ESD is determined to have influenced the portion of the image of the one of the plurality of block units.

17. The method as claimed in claim 16, wherein the determining of whether the ESD has influenced the portion of the image of each of the plurality of block units comprises:
detecting whether the portion of the image of each of the plurality of block units exists in an edge area; and
determining that the ESD has influenced the portion of the image if the portion of the image exists.

18. The method as claimed in claim 16, further comprising:
printing the image when the ESD does not influence the portion of the image of each of the plurality of block units.

19. The method as claimed in claim 16, further comprising:
transmitting the image to an external device when the ESD does not influence the portion of the image of each of the plurality of block units.
